(19) United States
(12) Patent Application Publication
(10) Pub. No.: US 2009/0319928 A1
(43) Pub. Date: Dec. 24, 2009

(54) GENERATING PREVIEWS FOR THEMES THAT PERSONALIZE AN OPERATING ENVIRONMENT

(75) Inventors: THOMAS HENRY ALPHIN, III, KIRKLAND, WA (US); RANDALL KNIGHT WINJUM, VASHON, WA (US); BRETT ALAN WALDBAUM, SAMMAMISH, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/143,376

(22) Filed: Jun. 20, 2008

(51) Int. Cl. G06F 3/048

(52) U.S. Cl. 715/765

(57) ABSTRACT

A computer media and method for generating visual previews for themes of an operating environment are provided. The visual previews are generated by a theme engine that retrieves files associated with each theme. The theme engine sizes and positions visual and non-visual elements corresponding to each theme. In turn, a gallery of visual previews are displayed to a user via a graphical user interface. The graphical user interface includes theme customization controls that allow the user to create personalized themes for the operating environment.

### BACKGROUND

Conventionally, an operating environment of a computing device displays themes as a list of textual selections or graphics that provide static theme information to a user of the computing device. The themes provided by the conventional operating environment allow the user to alter, among other things, desktop appearances, sounds, and pointer configurations. The conventional operating environment provides the user only with discrete localized information for parts of the theme. For instance, the discrete localized information includes the file name for the theme or an image for a background associated with the theme. The discrete localized information for the theme provides the user with a broad overview of the theme via the file name for the theme or the image associated with the theme.

The broad overview of the themes provided by the conventional operating environment are static because they are manually created by a designer. The text overview of the theme is limited to either a title or a description of the theme that is uneditable once the theme is installed in the computing device. Similarly, the broad overview of the theme that includes graphic is uneditable once the theme is installed in the computing device. Because the overview is manually created the conventional operating environment is unable to ensure that each broad overview contains similar styles or formats. The lack of control, by the operating environment, over the style, format, and content of the overview for each theme leads to inconsistencies regarding the nature of the theme information and quantity of the theme information that are communicated to the user. These inconsistencies negatively impact the user's experience with the themes.

### SUMMARY

A computer system includes a theme engine that generates visual previews for themes on the fly. The themes generated by the theme engine are for an operating environment associated with a computing device. The themes include visual elements and non-visual elements that are organized in a layout. The layout combines the visual elements and non-visual elements. In turn, the theme engine uses the layout to scale and position the visual elements and non-visual elements in visual previews. The theme engine generates a graphical user interface to display the visual previews. The graphical user interface includes theme customization controls, which receive user customization to personalize the themes.

This Summary is provided to introduce a selection of concepts in a simplified form. The selection of concepts are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram that illustrates an exemplary computing architecture associated with a computing device;

FIG. 2 is a screen shot that illustrates an exemplary graphical user interface for visual previews of themes of an operating environment of the computing device;

FIG. 3 is a screen shot that illustrates another exemplary graphical user interface for visual previews of themes;

FIG. 4 is a screen shot that illustrates an exemplary layout for the visual previews;

FIG. 5 is a screen shot that illustrates visual elements and non visual elements for the visual previews;

FIG. 6 is a screen shot that illustrates various styles for visual elements and non-visual elements for the visual previews;

FIG. 7 is a logic diagram for a method to generate visual previews for themes associated with the operating environment; and

FIG. 8 is a logic diagram for a method to personalize the themes and visual previews.

### DETAILED DESCRIPTION

This patent describes the subject matter for patenting with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described. Further, embodiments are described in detail below with reference to the attached drawing figures, which are incorporated in their entirety by reference herein.

As utilized herein, the term “theme” refers to a set of elements that create a coordinated look for an operating environment. The elements include, but are not limited to, sounds, backgrounds, icons, fonts, mouse pointers, brands, etc. The themes allow the user to customize and personalize the look and sounds of the operating environment.

In an embodiment, an operating environment of a computing device employs a theme engine to generate visual previews of themes stored on the computing device. The theme engine uses a theme gallery to display visual previews for each theme installed on the computing device. The theme engine retrieves visual elements and non-visual elements for each theme and creates the visual preview in real-time, which avoids manual preview generation. The theme engine retrieves visual elements such as window color and background to assemble an accurate visual preview of the elements associated with the theme. The gallery of visual previews provides one source and location to concurrently obtain useful information for multiple themes installed on the computing device. Additionally, the theme engine incorporates non-visual elements, such as sounds, logos, brands, or trademarks into the visual preview to allow an advertiser to promote a product along with a theme designed by the advertiser. The theme engine combines the visual elements and non-visual elements corresponding to each theme to dynamically create visual previews having consistency with respect to, among other things, format and style, for each visual preview.

The gallery of visual previews is presented to the user in a graphical user interface generated by the operating environment. The visual previews for the themes are sorted into groups based on a source and expected usage of the themes. Moreover, the graphical user interface includes theme customization controls for personalizing or customizing a subset of the visual and non-visual elements of the themes and visual previews. The users may use the theme customization controls to change the background, window color, sound, or screen saver. The changes to the theme are automatically reflected in the gallery of visual previews corresponding to the themes.

A computing device executes an operating environment, which allows the user to interface with the computing device. The computing device includes storage, processors, input/output (I/O) components, and presentation components to execute the operating environment and to process requests received from the user. The storage of the computing device stores themes, which include visual elements and non-visual elements. Moreover, the processors of the computing device are configured to implement a theme engine that generates the visual previews for each theme in the storage and graphical user interfaces to present the visual previews via the presentation components to the user.

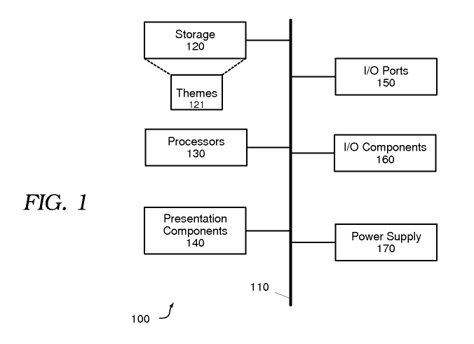

FIG. 1 is a block diagram that illustrates an exemplary computing architecture associated with a computing device 100. The computing device includes bus 110, storage 120, processors 130, presentation components 140, I/O ports 150, I/O components 160, and power supply 170.

The computing device 100 may be a personal computer, laptop computer, personal data assistant, mobile phone, or other handheld device. The computing device 100 is configured to read and execute computer code or machine-useable instructions, including computer-executable instructions such as program modules. Generally, program modules including routines, programs, objects, components, data structures, etc., refer to code that perform computing tasks or implement computing data types. In some embodiments, the computing device 100 may be implemented in a distributed computing environment where computing tasks are performed by processors 130, presentation components 140, and I/O components 160 that are linked through a communications network.

The bus 110, directly or indirectly, couples the following devices: the storage 120, the processors 130, the presentation components 140, the input/output ports 150, the input/output components 160, and the power supply 170. The bus 110 represents multiple computing buses that transfer data and control signals through the computing device. The bus 110 represents address buses, data buses, control buses or any combination thereof.

The storage 120 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, or any other medium that can encode desired information and be accessed by computing device 100. The storage 120 may be removable, nonremovable, or a combination thereof. Exemplary hardware devices include solid-state memory, hard drives, optical-disc drives, etc.

The storage 120 stores themes 121 having visual elements and non-visual elements. The themes 121 are accessed by a theme engine implemented by the processors 130 to generate visual preview in real-time. Moreover, the themes 121 are accessed to allow the user to customize the visual elements and non-visual elements of the theme via the theme engine implemented by processors 130.

The processors 130 read data from various entities such as storage 120 or I/O components 160. The processors 130 execute instructions associated with applications and program modules stored on the computing device 100. In some embodiments, the processors 130 implement the theme engine, which generates the graphical user interfaces and enables personalization of the themes 121.

The presentation components 140 include a display device, speaker, printing component, vibrating component, etc. The presentation components 140 present data indications to a user or other device. In an embodiment, the theme engine implemented by the processors 130 generate and send a graphical user interface to the presentation components 140. The graphical user interface includes a gallery of visual previews for each theme 121 and theme customization controls. The presentation components 140 receives and displays the graphical user interface to the user.

The I/O ports 150 are coupled to the presentation component 140 and the I/O components 160. The I/O ports 150 include serial ports, parallel ports, network interfaces, universal serial bus, firewire ports, and any other data transfer port. The I/O ports 150 allow the computing device 100 to interact with other external devices. The I/O ports also allow data transfer between the presentation components 140, the I/O components 160, storage 120, and the processors 130.

The I/O components 160 include microphones, joysticks, game pads, satellite dishes, scanners, printers, mice, wireless devices, etc. The I/O components 160 may be built into the computing device 100 or external to the computing device 100. The I/O components 160 allow a user or external device to interact with the computing device 100.

The power supply 170 powers the computing device 100. The power supply 170 may be a battery or an alternating current to direct current converter that converts an alternating current source to a direct current source. The power supply may be built into the computing device 100 or may be external to the computing device 100.

One of ordinary skill in the art understands and appreciates operating environment 100 has been simplified for description purposes and alternate operating environments are within the scope and spirit of the above description.

In certain embodiments, a computing device configured with a theme engine generates a gallery comprised of visual previews of each theme. The visual previews of each theme include the visual elements and non-visual elements of the theme. The gallery of visual previews is contained in a graphical user interface that is presented to a user of the computing device. The graphical preview includes theme customization controls that allow the user to personalize or customize the theme and corresponding visual preview.

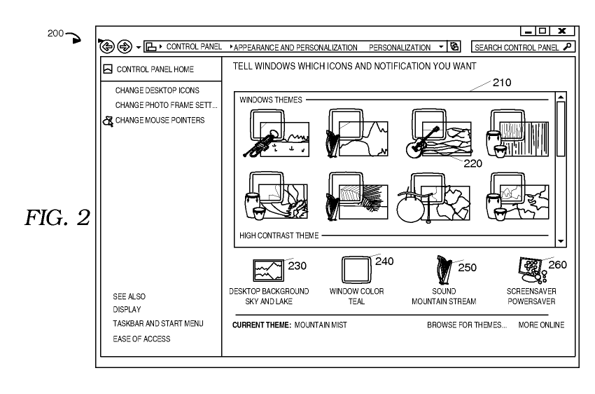

FIG. 2 is a screen shot that illustrates an exemplary graphical user interface 200 for visual previews 220 of themes of an operating environment of the computing device. The graphical user interface includes, among other things, a gallery 210, visual previews 220, and theme customization controls 230, 240, 250, and 260.

The gallery 210 is a scrollable display area of the graphical user interface 200 that displays each visual preview for each theme installed on the computing device. The installed themes include manufacturer themes, operating environment themes, and third-party themes. In some embodiments, a computing device having multiple users may have themes that have access restrictions. Some themes may be available to all users and other themes will be available only to the user that installed the other themes. For instance, a home computer with multiple users may have themes that all users can access. Additionally, the home computer may allow each user having a computer profile to store themes in a “my themes” section of the computer storage. The home computer restricts access to themes in the “my themes” section by making those themes accessible and viewable only by the user that installed the theme.

The gallery 210 is populated dynamically after a visual preview for the theme is created by a theme engine executing on the computing device. The theme engine locates the visual elements and non-visual elements for each theme, combines the visual elements and non-visual elements on a layout, creates the visual preview based on the preview generation rules, and sends the visual preview of each theme to the gallery 210. While the theme engine is generating the visual preview for each theme, the gallery 210 displays a default theme preview as a placeholder in the gallery 210 until the visual preview is completed by the theme engine.

The visual previews 220 are a single visual representation of the visual elements and non-visual elements of each theme installed on the computing device that a user is authorized to access and view. Generally, the visual elements represent things that are visually consumed by the user in a graphical format. The visual previews 220 include visual elements such as window color, background images, and screen savers. Generally, the non-visual elements represent things that are not visually consumed by the user in a graphical format. The visual previews 220 include non-visual elements such as images that represent the style and type of sound associated with theme or images associated with a brand corresponding to a designer or advertiser that designed the theme. The theme engine combines the visual elements and non-visual elements into a layout based on preview generation rules to create the visual previews 220. The preview generation rules direct the theme engine to scale and position both the visual elements and non-visual elements of the preview. In some embodiments, the preview generation rules cause the theme engine to include each of the visual elements and non-visual elements associated with the theme, but the theme engine limits the total number of both visual elements and non-visual elements included in the visual previews 220 to avoid visual previews that are crowded with too many visual elements and non-visual elements.

For instance, the theme engine may create a visual preview 220 for a “Mountain Mist” theme that includes a window color, background, and sound. The visual preview 220 generated by the theme engine includes visual elements—“teal” for the window color, “sky and lake” for the background images, and “bubbles” for the screen saver—and a non-visual element for a streaming sound represented by a harp. The non-visual element sound is represented by an image that corresponds to one or more instruments that may be used to create the sound associated with the theme. The theme engine uses the preview generation rules to consistently create the visual preview 220 for each theme installed in the computing device.

The preview generation rules are used to overlay each of the visual elements and non-visual elements. The preview generation rules specify a z-order, size, and position, for each of the visual elements and non-visual elements associated with the theme. The preview generation rules are used to implement an algorithm on the theme engine that automatically generates the visual preview 220 for the theme. The non-visual elements, such as sound and brand are included in the visual preview along with the visual elements, such as window color and background. The preview generation rules are used to combine non-visual elements that represent things that are not consumed by the user of the computing device in a visual manner with the visual elements of the theme.

The theme customization controls 230, 240, 250, and 260 represent the configurable visual elements and non-visual elements of the theme. Each of the theme customization controls is represented by a graphic that corresponds to the configurable visual elements and non-visual elements associated with each theme. The theme customization control 230 represents the background of the theme and allows the user to change the color of the background or to replace the background with a different background. The theme customization control 240 represents the window color of the theme and allows the user to change the color. The theme customization control 250 represents the sound of the theme and allows the user to change the style or type of sound. The theme customization control 260 represents the screensaver of the theme and allows the user to change the screen saver. Once, the user makes a change a new visual preview associated with the customized theme is included in the gallery 210. Moreover, the selection of the customized theme causes a system-wide change to occur on the computing device in accordance with the selected customized theme. The theme customization controls 230, 240, 250, and 260 are graphically displayed to the user to reinforce a relationship between each theme customization control 230, 240, 250, and 260 and the visual preview for the themes. Selecting a subsequent visual preview changes the text descriptions and graphics associated with each theme customization control 230, 240, 250, and 260 based on the configurable visual elements and non-visual elements associated with the theme. In an embodiment, clicking on one of the theme customization controls 230, 240, 250, or 260 causes the graphical user interface to change to an appropriate visual element or non-visual element dialog interface or causes a new graphical user interface to display an appropriate visual element or non-visual element dialog interface.

In certain embodiments, a gallery comprised of visual previews of each theme installed on a computing device is displayed to a user via a graphical user interface. The visual previews for each theme are sized to allow concurrent access to multiple visual previews. The graphical user interface includes controls that allow the user to customize icons and pointers of an operating environment of the computing device.

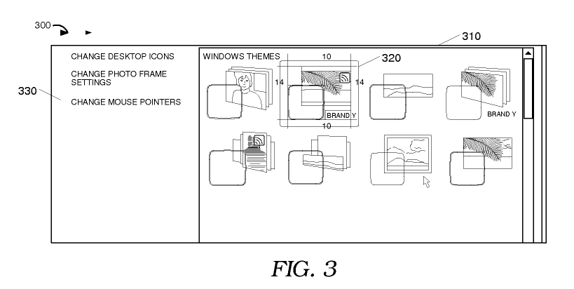

FIG. 3 is a screen shot that illustrates another exemplary graphical user interface 300 for visual previews 320 of themes. The theme engine generates the visual previews 320 and concurrently displays visual previews 320 for multiple themes.

The graphical user interface 310 displays visual previews 320 and includes a command section 330 to receive customization requests from a user. The computing device displays the graphical user interface 310 to the user and obtains the generated visual previews for each theme from the theme engine. In some embodiments, the graphical user interface 310 is configured to present the maximum number of visual previews 320 based on the size of a presentation component, such as a computer monitor or flat screen television. Optionally, the visual previews 320 are limited to a specific number of visual elements.

The visual previews 320 are sized to take a percentage of the display area. In some embodiments, each visual preview is sized to take 10% of the display area. Alternatively, the visual previews 320 may be sized to a specified pixel height and a specified pixel width. For instance, a visual preview 320 may be 10 pixels high by 14 pixels wide. The visual previews 320 include the visual elements: window color and background; and the non visual elements: brand and Really Simple Syndication (RSS) feeds associated with the theme. RSS feed in the visual preview 320 indicates that the theme content is updated periodically by a third-party. The computing device displaying the graphical user 310 interface checks the RSS feed regularly for theme updates, downloads the theme updates, and generates the updated visual previews 320.

The command section 330 allows the user to alter the color of the desktop icons, the shape and color of a mouse pointer, and the color borders for a digital image. When the user selects any of the commands in the command section 330, the graphical user interface 310 is changed to reflect the appropriate selection dialog. Alternatively, when the user selects any of the commands in the command section 330, the appropriate selection dialog is displayed in a new graphical user interface.

In some embodiments, the visual previews generated by the theme engine include a window color that is used as the border of the graphical user interfaces for applications that are executed on the computing device. The visual elements and non-visual elements of the visual previews are organized based on an algorithm that uses preview generation rules to check sizes and positions of each of the visual elements and non-visual elements to maintain a consistent look for each of the visual previews.

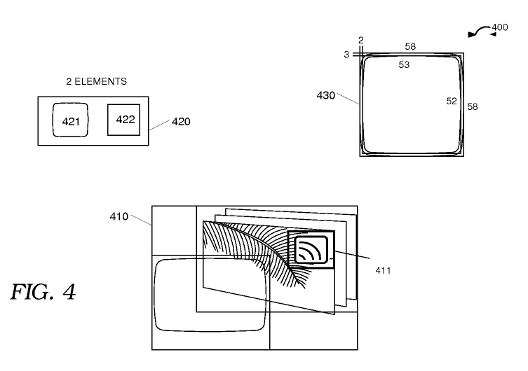

FIG. 4 is a screen shot that illustrates an exemplary layout 400 for the visual previews 410. In some embodiments, the visual previews 410 of the themes include two overlapping quadrilaterals 420 that represent the window color 430 of the theme. The visual preview 410 may include multiple backgrounds positioned in z-order to create a stack. In an embodiment, the multiple backgrounds may be associated with a RSS feed 411 that updates the background periodically.

The window color 430 is a display screen composed of the two overlapping quadrilaterals 420, which include a square 422 and rectangle 421 with rounded edges. In accordance with the preview generation rules, the theme engine positions the square 422, sizes the square 422 to an appropriate size, and sets the transparency to 100% allowing clear visibility to create the window color 430. In turn, the theme engine positions the rectangle 421 with rounded edges underneath rectangle 421, sizes the rectangle 421, fills the rectangle 421 with a specified theme color, and sets the transparency to an appropriate amount, such as 70%. The theme engine creates the window color 430 by combining the square 422 and rectangle 421 with rounded edges, which provides a window tint effect for graphical user interfaces. In certain embodiments, only a border of the window color 430 includes the window tint effect. In other words, the viewable area of the window color 430 displaying content associated with an application of the computing device is completely transparent and the border is semi-transparent. In some embodiments, the window color 430 includes a square 422 sized at 58 pixels by 58 and a rectangle 421 sized at 52 pixels by 53 pixels. The window color 430 created by the theme engine is scaled and positioned in the visual preview 410 in accordance with the preview generation rules.

In other embodiments, the visual previews generated by the theme engine are consistently generated based on an algorithm that uses preview generation rules to check sizes and positions for each of the visual elements and non-visual elements of theme. However, a user of the computing device may override the visual preview generated by the theme engine and replace the preview with an alternate visual preview for the theme.

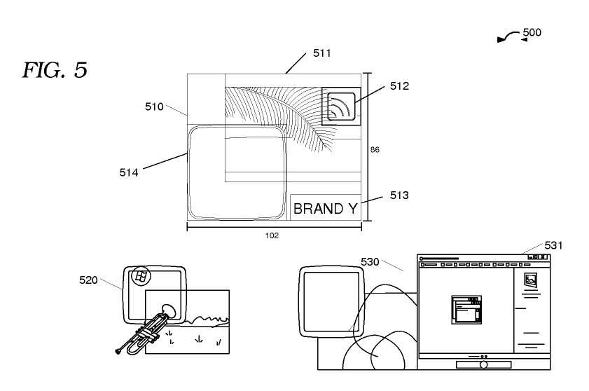

FIG. 5 is a screen shot 500 that illustrates visual elements 511 and 514 and non-visual elements 512 and 513 for the visual previews 510, 520, and 530. The preview generation rules are implemented by the theme engine as an algorithm for generating the visual previews. For instance, the algorithm may check each visual element and non-visual element associated with the theme, retrieve the visual elements and non-visual elements, scale and position the visual elements and non-visual elements in a layout to generate a visual preview 510, and send the visual preview 510 to the graphical user interface.

In an embodiment, the visual preview 510 includes a background 511, a RSS feed 512, a brand 513, and a window color 514. The theme engine generates the visual preview 510 by sizing and positioning each of the visual elements and non-visual elements. The visual preview 510 is appropriately sized to include a specified maximum number of both visual elements and non-visual elements. For instance, the specified maximum number of visual elements and non-visual elements may be set to a total of seven visual elements and non-visual elements, and the size of each visual preview 510 may be set to 86 pixels high and 102 pixels wide by the theme engine. The background 511 of the theme is positioned in the upper right corner of the visual preview 510 and appropriately sized. For instance, the size of the background 511 may be set to 64 pixels high by 80 pixel wide by the theme engine. The RSS feed 512 of the theme is appropriately sized and positioned in the upper right corner of the visual preview 510 by the theme engine. For instance, the size of a graphic that represents the RSS feed 512 is 23 pixels high by 23 pixels wide. The brand 513 of the theme is appropriately sized and positioned in the lower right corner of the visual preview 510 by the theme engine. The brand 513 gives a theme designer or an advertiser an opportunity to promote a product or service offered by the designer or advertiser to users of the computing device. The brand allows the user to determine who a source of the theme is or a location for the source of the theme. For instance, the size of a graphic that represents the brand 513 is 16 pixels high by 42 pixels wide. The preview generation rules prevent the brand from distracting the user's attention to the other visual elements and non-visual elements of the visual preview 510. The window color 514 of the theme is appropriately sized and positioned in the lower left corner of the visual preview 514 by the theme engine. For instance, the size of the window color 514 is 58 pixels high by 58 pixels wide.

The visual preview 520 shows an alternate layout configuration for the visual elements and non-visual elements of the theme. The visual preview 520 includes a sound, a background, a window color, and a brand. The alignment of the visual elements and non-visual elements for visual preview 520 differs from the visual preview in 510. The theme engine may chose the appropriate layout configuration based on the number and type of visual elements and non-visual elements associated with the theme. In an embodiment, the preview for the sound may include an audible sample that is played when the user selects the visual preview 520. Alternatively, the sound may be played when the user's pointer passes over the visual preview 520 or the visual preview 520 is placed in focus by the computing device. The sounds include, among other things, musical sounds, nature sounds, and special effect sounds that are associated with the theme of the visual preview 520.

The visual preview 530 is an alternate visual preview that a user may provide to the computing device to override the visual previews 510 or 520 generated by the theme engine. When a user chooses to override the visual preview 510 or 520, the computing device presents a dialog interface 531 that allows the user to select the alternate visual preview 530. In some embodiments, the alternate visual preview is a manually generated graphic that represents the user's interpretation of the theme. The theme engine ensures that the alternate visual preview is sized and positioned to be consistent with the other visual previews 510 or 520 generated by the theme engine.

In other embodiments, the theme engine generates visual previews having different formats and layouts based on the visual elements and non-visual elements of the theme. However, the theme engine uses the preview generation rules to ensure that the visual previews are consistent with the other visual previews that are concurrently displayed in the graphical preview. Moreover, the theme engine generates a generic preview that is used as a placeholder until the visual preview for the theme is complete.

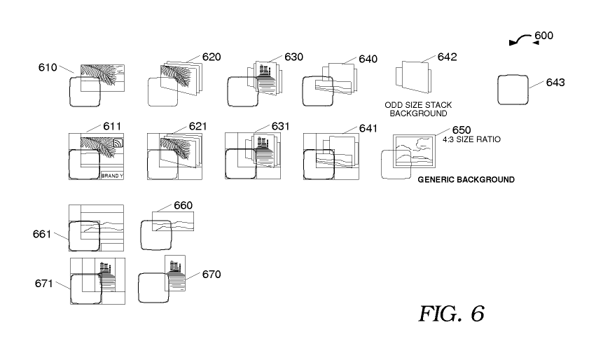

FIG. 6 is a screen shot 600 that illustrates various styles for visual elements and non-visual elements for the visual previews 611, 621, 631, 641, 661, and 671. The varying styles of the visual preview 611, 621, 631, 641, 661, and 671 are exemplary and other combinations of the visual elements and non-visual elements are contemplated. The themes include visual elements 610, 620, 630, 640, 650, 660, and 670.

A theme includes two visual elements 610. The two visual elements 610 are the window color and background for the theme. The visual preview 611 may be generated by the theme engine when the theme only includes two visual elements 610. Visual preview 611 includes a brand, a window color, and two backgrounds where at least one background is associated with a RSS feed. In visual preview 611, the background of the theme is scaled. Moreover, visual preview 611 is a layout that includes visual elements and non-visual elements.

Another theme may include two visual elements 620 that are the window color and a background having a stack of related background graphics for the theme. The related graphics of the background in the stack are each the same size. These two visual elements 620 may be scaled and positioned by the theme engine to create visual preview 621, which includes a window color and a background that is a stack having related background graphics. In some embodiments, the stack is illustrated by showing the first background graphic and a generic graphic representing multiple backgrounds as opposed to having each of the graphics for the background represented in the stack.

The two visual elements 630 of a theme may include the window color and background having a stack of related background graphics for the theme, where the related graphics of the background in the stack each are different sizes. This visual preview 631 may be generated by the theme engine based on the two visual elements 630. The visual preview 631 includes a window color and a background that is a stack having related background graphics. In some embodiments, the theme engine scales the height of the background graphics that have a large height to an appropriate size for the visual preview.

The two visual elements 640 of a theme may include the window color 643 and background 642 having a stack of related background graphics for the theme. This visual preview 641 may be generated by the theme engine based on the two visual elements 640. The visual preview 641 includes a window color 643, and a background 642 that is a stack having related background graphics. The related graphics of the background 641 in the stack each have different sizes. In some embodiments, the theme engine scales the width of the graphics of the background 642 that have a large width to an appropriate size for the visual preview 641.

In some embodiments, while the theme engine is generating a visual preview 611, 621, 631, or 641 the graphical user interface displays a generic visual preview 650. The generic visual preview 650 includes at least two visual elements. The two visual elements may include a window color and a background. After, the theme engine generates the visual preview for the theme, the graphical user interface is updated with the appropriate visual preview 611, 621, 631, or 641 for the theme. In other embodiments, the generic visual preview 650 is used as a placeholder while the user quickly scrolls through the visual previews 611, 621, 631, and 641 for the themes installed on the computing device.

The two visual elements 660 of a theme may include a window color and a wide background. The visual preview 661 may be generated by the theme engine based on the two visual elements 660. The visual preview 661 includes a window color and background. In some embodiments, the theme engine scales and aligns the background horizontally within an area set aside for the background in the visual preview 661.

The two visual elements 670 of a theme may include the window color and a tall background. The visual preview 671 may be generated by the theme engine based on the two visual elements 670. The visual preview 671 includes the window color and the tall background. In some embodiments, the theme engine scales and aligns the tall background vertically within an area set aside for the background in the visual preview 671.

In an embodiment, a computing device is configured with a theme engine that uses preview generation rules to layout visual elements and non-visual elements in a visual preview. The theme engine locates and retrieves the visual elements and non-visual elements of the theme. In turn, the theme engine based on the preview generation rules aligns and scales the visual elements and non-visual elements in the visual preview.

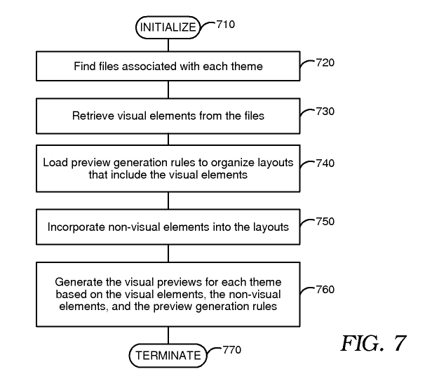

FIG. 7 is a logic diagram for a method to generate visual previews for themes associated with the operating environment. The method initializes in step 710. In step 720, the theme engine finds files associated with each theme to create a gallery of visual previews. The files are located in a storage associated with the computing device. For instance, the file may be a multimedia file or text file that describes the visual elements, the non-visual elements, a path to additional visual elements or non-visual elements for the theme, and color values associated with the theme. The theme engine retrieves the visual elements from the files associated with each theme, in step 730. In turn, the theme engine loads preview generation rules to organize layouts that include the visual elements that correspond with each theme, in step 740. In step 750, non-visual elements are incorporated into the layouts for each theme by the theme engine. In step 760, the theme engine generates visual previews for each theme based on the visual elements, non-visual elements, and the preview generation rules. In an embodiment, the preview generation rules prioritize the importance of the visual elements and non-visual elements. Based on the priority, the visual element and non-visual element are assigned positions, sizes, and z-orders by theme engine. In turn, the theme engine generates the appropriate visual preview and sends the preview to the graphical user interface to display the preview to the user. The method terminates in step 770.

In some embodiments, a computing device is configured with a theme engine that personalizes a theme and a corresponding visual preview. A graphical user interface showing the visual preview includes theme customization controls. The theme customization controls are used to customize and personalize the visual previews and themes. The changes may be immediately reflected in the visual preview or a current graphical user interface corresponding to the operating environment of the computing device.

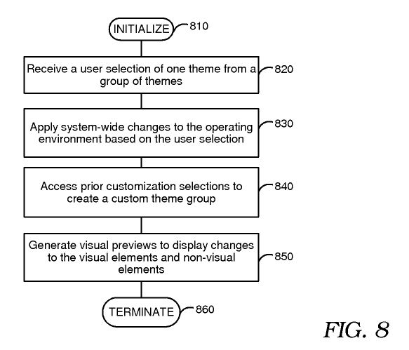

FIG. 8 is a logic diagram for a method to personalize the themes and visual previews. The method initializes in step 810. In step 820, the computing device receives a user selection of one theme from a group of themes displayed in the graphical user interface. In an embodiment, the user may select the color for the visual elements and non-visual elements of the theme or choose to add or omit visual elements and non-visual elements. In step 830, the computing device applies system-wide changes to the operating environment based on the user selection of one or more visual elements and non-visual elements associated with the theme. In an embodiment, the computing device does not require the user to confirm the changes to the operating environment. Instead, the operating environment is updated immediately without user confirmation of the change. In turn, the computing device accesses prior customization selections of the user to create a custom theme group, in step 840. In step 850, the computing device generates visual previews to display-in the custom theme group-the changes to the visual elements and non-visual elements selected by the user. In some embodiments, updating the visual preview for a theme and applying the system-wide change to the computing device occurs on an operating environment, such as Windows™ and Palm OS™. The method terminates in step 860.

In summary, an operating environment of a computing device presents available themes as a gallery of rich visual previews that showcase multiple elements of the theme. The elements of the theme are retrieved to generate the visual preview of the themes. In turn, the visual previews of each theme are sorted into groups, by the theme engine, based on the source and expected usage of the theme. A user of the computing device may personalize or customize the elements of the themes and visual previews through theme customization controls.

The foregoing descriptions of the invention are illustrative, and modifications in configuration and implementation will occur to persons skilled in the art. For instance, while the present invention has generally been described with relation to FIGS. 1-8, those descriptions are exemplary. Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims. The scope of the invention is accordingly intended to be limited only by the following claims.

The invention claimed is:

1. A method to generate a gallery of visual previews for themes associated with an operating environment of a computing device, the method comprising:
finding files associated with each theme to create the gallery of visual previews;
retrieving visual elements from the files associated with each theme;
loading preview generation rules to organize layouts that include the visual elements that correspond with each theme;
incorporating non-visual elements into the layouts for each theme; and
generating visual previews for each theme based on the visual elements, non-visual elements, and the preview generation rules.

2. The method of claim 1, wherein the themes include manufacturer installed themes, operating environment installed themes, Internet installed themes, and user customized themes.

3. The method of claim 1, wherein the non-visual elements include at least sounds, brand, and Real Simple Syndication (RSS) feeds associated with one or more themes.

4. The method of claim 1, wherein the visual elements include at least background images, window colors, and screen savers.

5. The method of claim 1, further comprising combining multiple visual elements and non-visual elements into a single visual representation.

6. The method of claim 5, further comprising scaling the retrieved visual elements and positioning the visual elements within the single visual representation based on the preview generation rules.

7. The method of claim 1, wherein visual elements for a theme currently in focus are displayed individually as theme customization controls.

8. One or more computer readable media storing instructions for performing a method for generating a visual preview of a theme for an operating environment of a computing device, the method comprising:
finding files associated with each theme to create a gallery of visual previews;
retrieving visual elements associated with each theme;
loading preview generation rules to organize layouts that include the visual elements that correspond with each theme;
incorporating non-visual elements into the layouts for each theme; and
generating visual previews for each theme based on the layouts and the preview generation rules.

9. The media of claim 8, wherein visual elements for a theme currently in focus are displayed individually as theme customization controls.

10. The media of claim 9, wherein the theme customization controls allows a user to replace the generated visual previews with an alternate visual preview.

11. The media of claim 9, wherein the individual visual elements that represent the theme customization controls are updated when the user browses the gallery of visual previews and changes focus from a previous visual preview to a subsequent visual preview contained in the gallery.

12. The media of claim 8, wherein the themes include manufacturer installed themes, operating environment installed themes, Internet installed themes, and user customized themes.

13. The media of claim 8, wherein the non-visual elements include at least sounds, brand, and Real Simple Syndication (RSS) feeds associated with one or more themes.

14. The media of claim 8, wherein the visual elements include at least background images, window colors, and screen savers.

15. A method for personalizing an operating environment of a computing device, the method comprising:
receiving a user selection of one theme from a group of themes displayed in graphical user interface;
applying system-wide changes to the operating environment based on the user selection of one or more visual elements and non-visual elements associated with the theme;
accessing prior customization selections of the user to create custom theme group; and
generating visual previews to display the changes to the visual elements and non-visual elements selected by the user in the custom theme group.

16. The method of claim 15, wherein the system-wide change affects all visual elements and non-visual elements selected by the user.

17. The method of claim 16, wherein the visual elements include at least two of the following: window colors, backgrounds, and screen savers.

18. The method of claim 16, wherein the non-visual elements include at least one of the following: sounds, brands, and Really Simple Syndication feeds.

19. The method of claim 15, wherein the user selects theme customization controls that represent the visual elements of one or more themes to create a custom theme.

20. The method of claim 15, wherein the user selections include an override visual preview selection that allows the user to provide an alternate preview for one or more themes.
